(19) United States
(12) Patent Application Publication
(10) Pub. No.: US 2004/0190567 A1
(43) Pub. Date: Sep. 30, 2004

(54) Optically pumped laser device for generating laser pulses

(75) Inventors: Stephan Lutgen, Regensburg (DE); Peter Brick, Regensburg (DE)

Correspondence Address: COHEN, PONTANI, LIEBERMAN & PAVANE, Suite 1210, 551 Fifth Avenue, New York, NY, 10176, US

(73) Assignee: Osram Opto Semiconductors GmbH, Regensburg (DE)

(21) Appl. No.: 10/783,143

(22) Filed: Feb. 19, 2004

(30) Foreign Application Priority Data
Feb. 19, 2003 (DE) 103 06 997.6

(51) Int. Cl. H01S 3/098; H01S 3/10; H01S 3/082

(52) U.S. Cl. 372/25; 372/97; 372/18

(57) ABSTRACT

A laser device for generating laser pulses with an optically pumped semiconductor laser (1), which has an external resonator and at least one mode-locker (10).

### RELATED APPLICATION

This patent application claims the priority of the German Patent Application 103 06 997.6, the disclosure content of which is hereby incorporated by reference.

### FIELD OF THE INVENTION

The present invention relates to an optically pumped laser device.

### BACKGROUND OF THE INVENTION

Optically pumped laser devices are disclosed for example in U.S. patent application Ser. No. 09/824,086, which describes semiconductor bodies with a vertical emitter, which is optically pumped by an internal pump radiation source, preferably an edge-emitting laser. The vertical emitter and the pump radiation source are embodied in a monolithically integrated fashion in this case. The content of this document is hereby incorporated by reference in the present description.

Furthermore, devices with a vertical emitter which is optically pumped by an external pump radiation source are also known. Internally and externally pumped vertical emitters are summarily also referred to as semiconductor disc lasers, or as disc lasers, hereinafter.

In order to generate laser pulses, in lasers of this type, the pump radiation source, for example, may be operated in a pulsed manner. Furthermore, methods such as gain switching or Q switching are known for generating laser pulses. The pulse durations which can thereby be achieved typically lie in the microseconds to nanoseconds range and are thus considerably greater than a picosecond.

In order to realize shorter pulse durations, the principle of mode-locking is used in conventional lasers such as, for example, dye lasers, titanium-sapphire lasers or flash lamp-pumped Nd:YLF lasers.

In the case of mode-locking, a plurality of modes of a laser resonator are coupled in a phase-locked manner in such a way that the resulting electromagnetic field corresponds to a short pulse which circulates in the resonator.

In the case of mode-locking, a distinction is made between active and passive mode-locking. Active mode-locking is based on a modulation of the resonator losses, for example by means of an electro-optical modulator which is excited in a manner coordinated with the resonator length. However, active mode-locking requires, in addition to a suitable medium, external radio frequency driving, which thus increases the outlay for active mode-locking.

In the case of passive mode-locking, by contrast, the resonator-internal electromagnetic field itself generates a modulation of the resonator losses or of other resonator properties, which in turn reacts upon the resonator-internal radiation field. One example of passive mode-locking is Kerr lens mode-locking (KLM) or self-phase modulation (SPM) in the case of a titanium-sapphire laser.

The pulse duration that can be achieved in this case depends, inter alia, on the gain bandwidth of the laser medium or the number of modes that can be coupled.

Semiconductor lasers are generally operated without mode-locking. This is due, inter alia, to the fact that the resonator is often formed by side areas of the semiconductor laser chip and is thus not accessible for a separate mode-locker. Moreover, in conventional semiconductor lasers, the gain bandwidth and the radiation intensity are generally insufficient for passive mode-locking.

### SUMMARY OF THE INVENTION

It is an object of the present invention to provide a laser device of the type mentioned in the introduction for generating laser pulses. The pulse duration is intended in particular to be in the picoseconds or femtoseconds range.

This and other objects are attained in accordance with one aspect of the invention directed to a laser device for generating laser pulses with an optically pumped semiconductor laser, comprising an external resonator and at least one mode-locker.

The invention provides a laser device for generating laser pulses with an optically pumped semiconductor laser. The semiconductor laser can have an external resonator, in which at least one mode-locker is arranged. Alternatively, the mode-locker can be integrated as an internal mode-locker into the semiconductor body. In addition, part of the part of the mode-locker can be internal and part can be external. A two-stage construction with an external mode-locker, for example for starting the mode-locking, in conjunction with an internal mode-locker for further pulse shortening or stabilization of the mode-locking is advantageous.

It has been shown within the scope of the invention that, in the case of an optically pumped semiconductor laser, both the gain bandwidth and the radiation intensity that can be achieved lie in a range which enables in particular passive mode-locking.

In an advantageous manner, in the case of an optically pumped semiconductor laser with an external resonator, the resonator length is freely selectable within wide ranges, so that enough space is available for an external mode-locker. Furthermore, the resonator length may be selected such that a number of resonator modes which is sufficient for mode-coupled operation is present within the gain bandwidth.

The invention thus makes it possible to realize a highly efficient light source for generating short pulses, in particular in the picoseconds or femtoseconds range, which is additionally distinguished by a good beam quality. Furthermore, a compact design is possible, largely using semiconductor components.

In a first embodiment of the invention, provision is made of an external pump radiation source for pumping the semiconductor laser. A conventional edge-emitting diode laser is preferably used for this purpose. This embodiment is distinguished by a comparatively simple structure of the semiconductor laser. Furthermore, it is possible to use readily available and commercially obtainable components as the pump radiation source. Finally, both the pump radiation source and the optically pumped semiconductor laser are easily accessible, it being possible to vary the arrangement of the components within wide limits.

A second embodiment of the invention has an optically pumped semiconductor laser with a monolithically integrated pump radiation source. In this embodiment, the laser device comprises a particularly small number of individual components, which thus advantageously reduces the outlay for mounting and adjustment. Furthermore, this embodiment is distinguished by high stability on account of the monolithic integration of pump radiation source and semiconductor laser.

The mode-locker is preferably embodied as a passive mode-locker. It has been found within the scope of the invention that, in the case of an optically pumped semiconductor laser of the type mentioned, it is possible to generate resonator-internal radiation fields with such high intensities that passive mode-locking is possible. Compared with an active mode-locker, a passive mode-locker has the advantage that no external driving is necessary.

The mode-locker is preferably embodied as a saturable absorber, in particular made of a semiconductor material. A saturable absorber requires a comparatively low radiation intensity compared with other passive mode-lockers. As a result, on the one hand, the requirements made of the pump radiation source are advantageously lowered, since mode-coupled operation is possible even with a relatively low pump power. On the other hand, the starting of mode-coupled operation is facilitated by means of a saturable absorber.

During the starting of mode-coupled operation, the laser device generally undergoes transition from continuous wave operation with the radiation intensity typical thereof into stationary mode-coupled operation, which is maintained at significantly higher intensities. A mode-locker which requires only a low radiation intensity facilitates this transition. The stationary mode-coupled operation can be supported and stabilized by further mode-locking mechanisms such as Kerr lens mode-locking, self-phase modulation or else cross-phase modulation.

Moreover, saturable absorbers are advantageous for suppressing continuous wave operation which undesirably occurs simultaneously to the mode-coupled operation.

It should be noted, however, that a different suppression of continuous wave operation without a saturable absorber is also possible within the scope of the invention. This may be done using for example the thermal lenses and/or Kerr lenses which are different for mode-coupled operation and continuous wave operation in conjunction with a slight defocusing of the resonator-internal radiation field with regard to the laser-active medium.

Semiconductor-based saturable absorbers may also be combined with a mirror, in particular a resonator mirror. This reduces the number of components and thus the mounting and adjustment outlay. Furthermore, such a combination of mirror and saturable absorber exhibits the occurrence of excessive field increases which further reduce the intensity required for passive mode-locking. Mode-lockers of this type are also known as SESAM (SEmiconductor Saturable Absorber Mirror).

As an alternative, such a saturable absorber may also be integrated into the semiconductor body of the semiconductor laser. A semiconductor-based saturable absorber generally has, like the semiconductor laser, a plurality of semiconductor layers.

By way of example, a saturable absorber may be embodied as a quantum well structure. For use as a saturable absorber for generating short and ultrashort pulses, the luminescence lifetime of said quantum well structure should be as short as possible. This may be achieved, on the one hand, by the quantum well structure being arranged near the surface, so that the comparatively rapid surface recombination contributes to a short luminescence lifetime. On the other hand, a short luminescence lifetime may be achieved by growing the quantum well structure at comparatively low temperatures, for instance in the range of between 300° C. and 500° C.

In the case of a combination with a mirror such as a Bragg mirror, for example, it is furthermore advantageous to arrange the quantum well structure of the saturable absorber so near to the mirror that an incident part of a pulse is superposed with an already reflected part of the pulse in the region of the quantum structure and an excessive increase in the radiation field thus arises.

If these semiconductor layers are grown in a common production process, then the production outlay for a laser device according to the invention can advantageously be reduced. Moreover, a very compact laser device for generating short pulses can be realized in this way.

In an advantageous development of the invention, a device for phase compensation is arranged within the external resonator. In laser devices for generating ultrashort pulses in the picoseconds and femtoseconds range the minimum pulse duration that can be achieved is influenced by the group velocity dispersion (also known as group delay dispersion) in the laser resonator. A device for phase compensation compensates for the group velocity dispersion within the resonator and thus advantageously reduces the pulse duration. In particular, sub-picosecond pulses and femtosecond pulses can thus be generated within the scope of the invention.

The device for phase compensation may have for example prisms, gratings, linear or chirped mirrors, lenses and/or optical fibers. The construction of a device for phase compensation with a prism system comprising four prisms is known per se for example for titanium-sapphire lasers and, therefore, is not explained further at this juncture.

Furthermore, a chirped mirror may be used for phase compensation. During the reflection of a radiation pulse, a chirped mirror simultaneously modifies the frequency distribution of said radiation pulse. Since the group velocityed dispersion also leads to different propagation times of the individual spectral components of a pulse and thus to a modification of the frequency distribution of said pulse, a correspondingly adapted chirped mirror may be used for canceling said modification, that is to say for phase compensation. By way of example, it is possible to use a chirped mirror in the case of folded resonator as a folding mirror.

A further refinement of the invention has a resonator with two resonator branches, a first resonator branch being provided for generating laser pulses having a fundamental wavelength λ₁ and a second resonator branch being provided for generating laser pulses having a fundamental wavelength λ₂ (two-color laser). In an advantageous manner, laser pulses of different wavelength can thus be generated simultaneously by means of one laser device. This laser device can also be used for generating continous wave laser radiation of two wavelenghts λ₁ and λ₂ by switching off or detuning the mode-locker.

Mode-coupled operation is particularly advantageous in the case of such a two-color laser. In the event of a reciprocal interaction of the laser pulses having the wavelengths λ₁ and λ₂, said mode-coupled operation enables their phase-locked coupling, so that the laser pulses are temporally synchronized.

### BRIEF DESCRIPTION OF THE DRAWINGS

Further features, advantages and expediences of the invention emerge from the following description of seven exemplary embodiments in conjunction with FIGS. 1 to 8, in which:

FIG. 1 shows a diagrammatic illustration of a first exemplary embodiment of a laser device according to the invention,

FIG. 2 shows a diagrammatic illustration of a second exemplary embodiment of a laser device according to the invention,

FIG. 3 shows a diagrammatic graphical illustration of the group velocity dispersion and the gain as a function of the wavelength in the case of the first exemplary embodiment of a laser device according to the invention,

FIG. 4 shows a diagrammatic illustration of a third exemplary embodiment of a laser device according to the invention,

FIG. 5 shows a diagrammatic illustration of a fourth exemplary embodiment of a laser device according to the invention,

FIG. 6 shows a diagrammatic illustration of a fifth exemplary embodiment of a laser device according to the invention,

FIG. 7 shows a diagrammatic illustration of a sixth exemplary embodiment of a laser device according to the invention, and

FIG. 8 shows a diagrammatic illustration of a seventh exemplary embodiment of a laser device according to the invention.

### DETAILED DESCRIPTION OF THE DRAWINGS

Identical or identically acting elements are provided with the same reference symbols in the Figures.

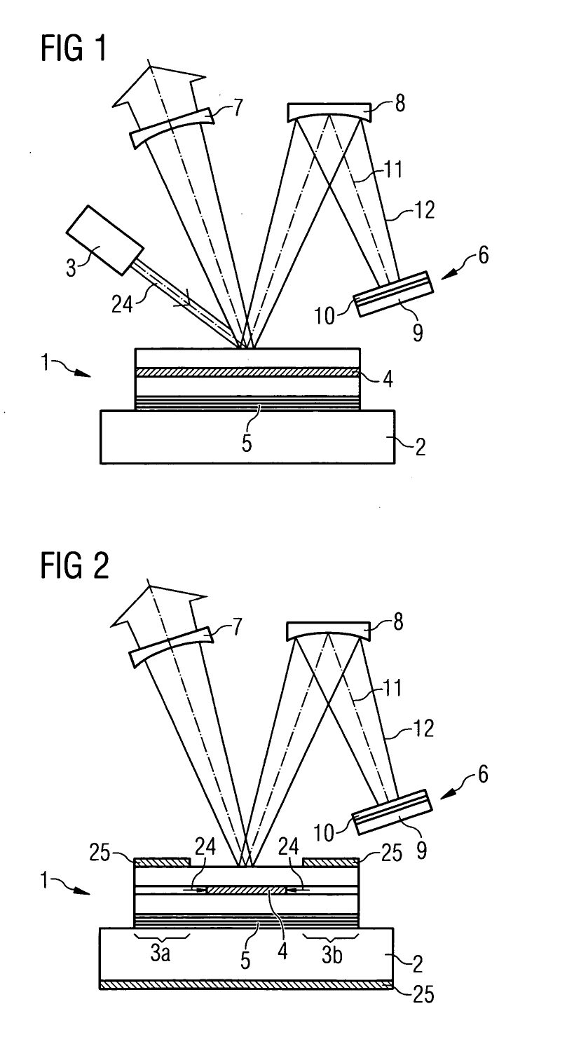

The laser device illustrated in FIG. 1 has a semiconductor laser 1 mounted onto a heat sink 2. Materials such as InGaAIP, InAIGaN, AlGaAs, InGaAsP, GaAsN, InGaAsN, GaSb and InP are suitable, for example, as semiconductor material.

The semiconductor laser 1 is formed as a disc laser which is optically pumped by an external pump radiation source 3. In this case, the pump radiation 24 is preferably radiated obliquely onto the coupling-out surface of the semiconductor laser 1.

In detail, the semiconductor laser comprises, inter alia, an active layer 4 with a vertically emitting quantum well structure, which may be arranged for example between waveguide layers, and/or cladding layers.

On that side of the active layer 4 which faces the heat sink 2, the semiconductor laser furthermore has a mirror layer 5, which is preferably embodied as a Bragg mirror.

The resonator of the semiconductor laser is embodied as an external resonator and is formed by an SESAM 6, a coupling-out mirror 7, a first folding mirror 8 and also the mirror layer 5, which constitutes a second folding mirror.

In the SESAM 6, a saturable semiconductor absorber 10 is combined with a mirror 9. The saturable semiconductor absorber 10 serves as a mode-locker in the laser resonator and the mirror 9 simultaneously serves as a resonator end mirror.

The radiation field which forms in the external resonator during operation is illustrated diagrammatically using a beam axis 11 and a beam radius 12. The beam radius used may be, by way of example, the beam radius to an approximation of Gaussian optics.

The coupling-out mirror and the folding mirror are concave mirrors whose radius of curvature and arrangement are chosen in each case in such a way that a beam waist and thus an intensity maximum of the resonator-internal radiation field arise in the region of the SESAM 6, on the one hand, and in the region of the semiconductor laser 1, on the other hand. This configuration is advantageous for the mode-locking by means of the saturable absorber 10 and also for an efficient interaction with the pump radiation of the pump radiation source 3.

During operation, the laser device initially starts in continuous wave operation at low pump powers. Given a sufficiently high pump power, a slight external disturbance may effect a momentary modulation of the resonator properties, which initially leads to an uncontrolled pulsed operating state. The laser pulses that arise in this case have a higher intensity that the radiation field in continuous wave operation, so that said laser pulses saturate the absorber 10 to a correspondingly greater extent, i.e. reduce the absorption of said absorber during the passage of a pulse to a higher degree, than the radiation field in continuous wave operation. Consequently, the round-trip losses for laser pulses are lower than for uncoupled continuous wave modes, the laser pulses are amplified to a greater extent during each resonator round-trip in the semiconductor laser 1 and mode-coupled in the SESAM 6 until a stationary mode-coupled operating state is reached.

The pulse duration that can thereby be achieved lies in the picoseconds and sub-picoseconds range, typically approximately between 15 ps and 500 fs.

FIG. 2 illustrates a second exemplary embodiment of the invention. This exemplary embodiment differs from the first exemplary embodiment primarily in the fact that the semiconductor laser has a monolithically integrated pump radiation source 3a, 3b.

In detail, there is formed in the semiconductor body an active layer 4 with a vertically emitting quantum well structure. The vertically emitting quantum well structure is positioned between two pump radiation sources 3a, 3b, preferably edge-emitting lasers that are arranged laterally adjacent to the vertically emitting quantum well structure.

For the electrical supply of the pump radiation source 3a, 3b, contact areas 25 are arranged on the top side of the semiconductor body and on the rear side of the heat sink 2. Within the scope of the invention, and in particular in the exemplary embodiments described, such a disc laser with an integrated pump radiation source may be provided instead of an externally pumped disc laser, and vice versa.

The vertically emitting quantum well structure has a plurality of semiconductor layers which form the quantum wells. Between two adjacent semiconductor layers of this type, a semiconductor layer or a plurality of semiconductor layers is in each case arranged as a barrier.

In the case of the invention, two different pump modes are possible both in the case of an external and in the case of an integrated pump radiation source.

In the case of the first pump mode, the wavelength of the pump radiation is coordinated with the vertically emitting quantum well structure in such a way that the pump radiation is predominantly absorbed in the semiconductor layers which form the quantum wells.

This pump mode is advantageous in particular for a semiconductor laser with an integrated pump radiation source, in order to pump the radiation-emitting region of the vertical emitter as homogeneously as possible.

In the case of the second pump mode, the pump radiation is predominantly absorbed in the barriers, as a result of which charge carrier pairs arise and subsequently recombine in the quantum wells.

The embodiment of the semiconductor laser as a disc laser with an integrated pump radiation source is particularly suitable for the further integration of a saturable absorber into the semiconductor laser. In this way, it is possible to realize an extremely compact component for generating laser pulses which is distinguished by short pulse durations in conjunction with a high intensity. Moreover, only one external resonator mirror is necessary for operation.

Preferably, such a semiconductor laser has, from the coupling-out side of the vertically emitting quantum well structure, a quantum well structure forming the saturable absorber, for example with two quantum wells, followed by the active layer of the vertical emitter, i.e. the vertically emitting quantum well structure, and arranged downstream of the latter a mirror layer, for example a Bragg mirror.

In the exemplary embodiments illustrated in FIGS. 1 and 2, the minimum pulse duration that can be realized is limited, inter alia, by the group velocity dispersion in the resonator.

The group velocity specifies the speed at which the centroid of a wave packet moves in a medium. The dependence of the group velocity on frequency is referred to as the group velocity dispersion.

In the laser resonator, the group velocity dispersion of the different components, in particular of those with larger optical path lengths or penetration depths has the effect that different spectral components of a pulse have different propagation times in the resonator, as a result of which the pulse duration is lengthened overall. The minimum pulse duration is determined by the operating state in which pulse shortening due to mode-locking and pulse lengthening due to group velocity dispersion compensate one another.

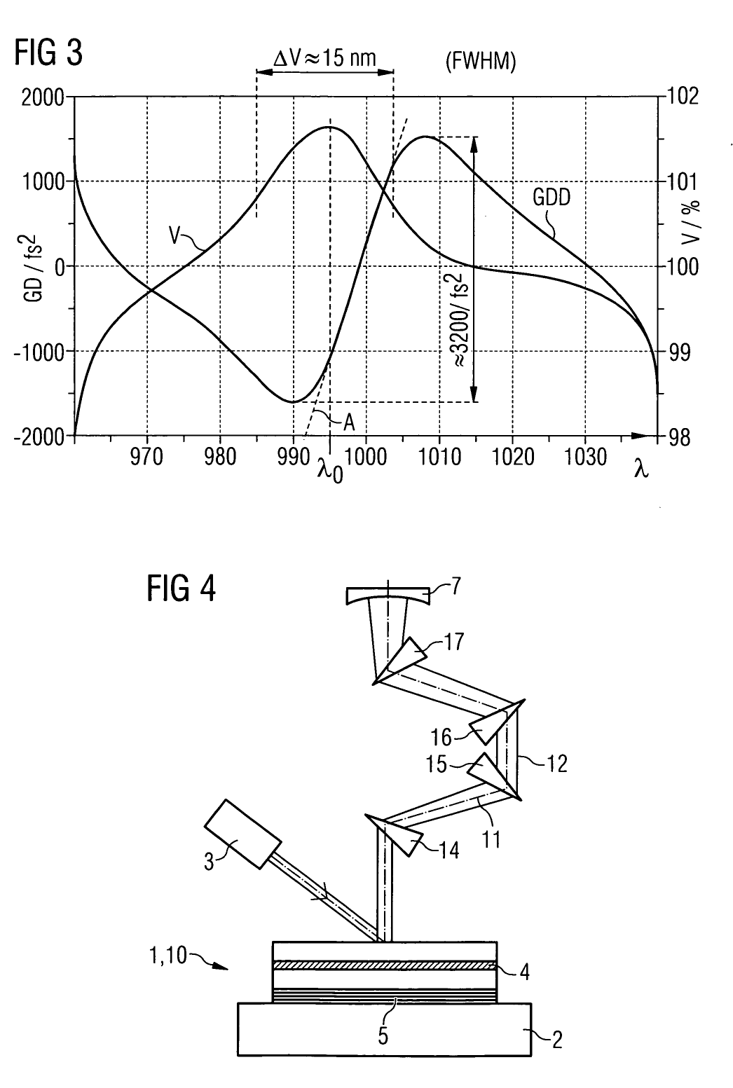

FIG. 3 illustrates the group velocity dispersion and the gain for a laser device corresponding to FIG. 1. The calculated group delay GD and the gain V are plotted as a function of the wavelength.

The calculations were carried out for an active layer 4 with a quantum Well structure designed for an emission wavelength of λ₀=995 nm. The gain V was converted into a fictitious reflection, a reflection of 100% corresponding to a gain of 1.00.

In the region of the emission wavelength λ₀ the group velocity dispersion has an approximately linear wavelength dependence with a positive gradient as illustrated by the broken line A.

Toward longer wavelengths, a maximum of the group velocity dispersion occurs, followed by a fall in the group velocity dispersion. For shorter wavelengths, the profile of the group velocity dispersion is approximately centrosymmetrical with respect to the zero crossing in the vicinity of λ₀ with a minimum beyond which the group velocity dispersion rises again.

The approximately linear wavelength dependence in the region of the emission wavelength λ₀ leads to a frequency distribution which is also referred to as a linear chirp in the case of the laser pulses generated. A nonlinear chirp or a higher-order chirp respectively corresponds to the maximum or minimum of the group velocity dispersion.

Overall, the following emerges from this within the scope of the invention: the disc lasers mentioned in the introduction have a gain bandwidth which even suffices for generating femtosecond pulses. Thus, a gain bandwidth ΔV of about 15 nm results from FIG. 3. For sech pulses, which are typical in the femtosecond range, a bandwidth product of 0.315 results from the energy-time-indeterminacy relationship, so that a pulse duration of about 70 fs corresponds to the aforementioned gain bandwidth ΔV.

Moreover, it is advantageous with regard to a largest possible gain bandwidth to provide the semiconductor laser with a correspondingly broadband antireflection layer. This antireflection layer may comprise for example a dielectric layer sequence or epitaxially grown layer sequence.

The gain bandwidth can be increased further by the formation of various quantum films with a respective gain at different wavelengths within the quantum film structure.

As can further be gathered from FIG. 3, the group velocity dispersion per resonator round-trip is about 3200 fs². Without phase compensation, this leads to a pulse duration lengthening, so that the pulse duration that can be achieved solely with a mode-locker is significantly greater than the minimum pulse duration resulting from the bandwidth product and the gain bandwidth. In order to further reduce the pulse duration, therefore, a phase compensation is necessary which compensates for the linear chirp, in particular,

A laser device with such a phase compensation device is illustrated in FIG. 4 as a third exemplary embodiment of the invention. As in the exemplary embodiment shown in FIG. 1, a disc laser 1 pumped by an external pump radiation source 3 is provided, the external resonator of which laser is formed by the mirror layer 5 integrated in the disc laser and the coupling-out mirror 7.

A prism system having four prisms 14, 15, 16, 17 is arranged in the resonator. In the case of this prism system, different optical paths or different propagation times result on account of the dispersion of the prisms, depending on the wavelength. The prism system is designed in such a way that the group velocity dispersion or the linear chirp caused thereby is compensated for by means of the different propagation times.

In contrast to the exemplary embodiment illustrated in FIG. 1 a saturable absorber or SESAM is not provided in the arrangement shown in FIG. 4. Rather, the semiconductor body of the disc laser simultaneously functions as an internal mode-locker 10 according to the principle of Kerr lens mode-locking. In this case, the nonlinear refractive index of the semiconductor material in the semiconductor laser 1 is utilized for the Kerr lens mode-locking.

The nonlinear refractive index specifies the dependence of the refractive index on the radiation intensity. A laser pulse thus leads to a spatial and temporal refractive index change which approximately corresponds to a time-dependent lens, the so-called Kerr lens. In Kerr lens mode-locking, the resonator is designed in such a way that a laser pulse, on account of the Kerr lens which it itself generates, circulates in the resonator with a particularly low loss and/or overlaps the pump volume particularly well. A thermal lens that occurs, if appropriate, may in this case act in a supporting manner or additionally stabilize the resonator.

As an alternative, a saturable absorber may also be integrated as internal mode-locker into the semiconductor body.

Instead of the prism system shown, any other device for phase compensation may also be used within the scope of the invention. A higher-order phase compensation may also be advantageous. In particular, a device with one or a plurality of chirped mirrors, an arrangement with gratings as dispersive elements, a corresponding arrangement with lenses and mirrors or a combination of an optical fiber with a grating may be used for this purpose. Combinations of these devices with one. another may also be provided for the purpose of phase compensation.

Furthermore, as an alternative or in addition, one of the aforementioned devices for phase compensation may be arranged downstream of the resonator, so that the coupled-out laser pulses are temporally compressed by said device.

In another variant of the invention, the device for phase compensation, preferably in the form of a chirped mirror, is likewise integrated into the semiconductor body.

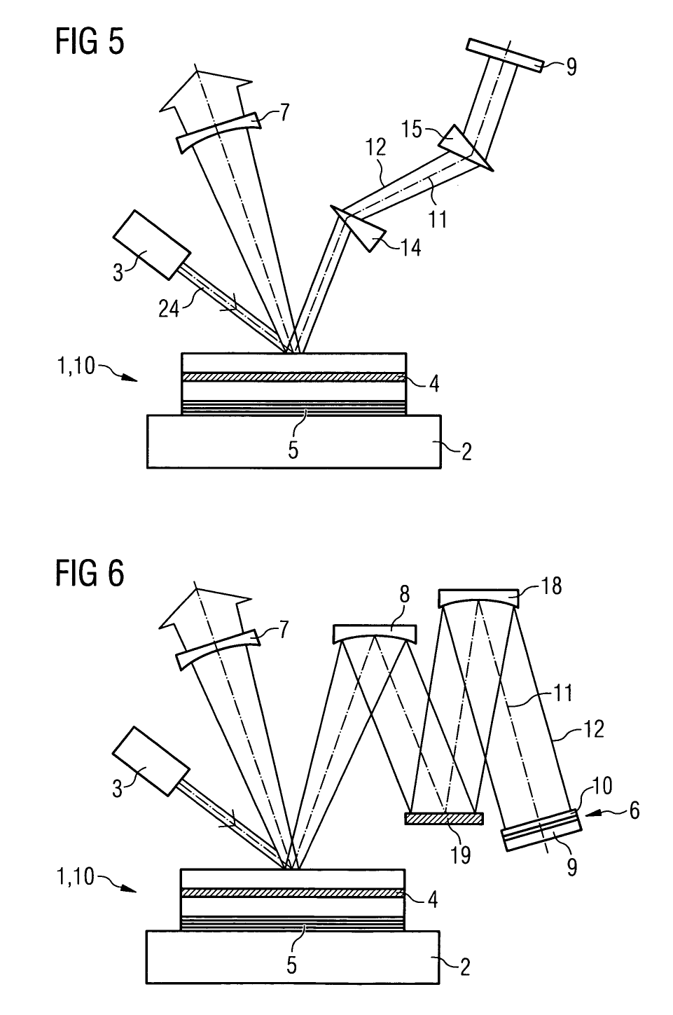

FIG. 5 illustrates a fourth exemplary embodiment of the invention. In contrast to the exemplary embodiment shown in FIG. 4, here a prism system with two prisms 14, 15 in conjunction with an end mirror 9 is provided for phase compensation, which end mirror mirrors the prism system into itself. As in the previous exemplary embodiment, the semiconductor body of the disc laser 1 serves as mode-locker 10 according to the principle of Kerr lens mode-locking. As an alternative, the end mirror 9 may be embodied as an SESAM or an SESAM may be integrated into the disc laser. The exemplary embodiment illustrated in FIG. 5 is distinguished by the fact that the device for phase compensation has comparatively few components and, consequently, the number of surfaces or the scattering losses at surfaces are advantageously reduced, which leads to reduced round-trip losses in the resonator.

FIG. 6 illustrates a fifth exemplary embodiment of the invention. The laser device largely corresponds to the exemplary embodiment illustrated in FIG. 1. In contrast thereto, the resonator is folded two more times between the folding mirror 8 and the semiconductor laser 1.

This folding is formed by an additional folding mirror 18 and a chirped mirror 19. The chirped. mirror 19 is dimensioned in such a way that it compensates for the linear chirp arising on account of the group velocity dispersion and, if appropriate, also the nonlinear chirp. It is advantageous that a particularly small number of components are required in this case for phase compensation, a chirped mirror additionally being distinguished by a very good surface quality or low scattering losses at the surface.

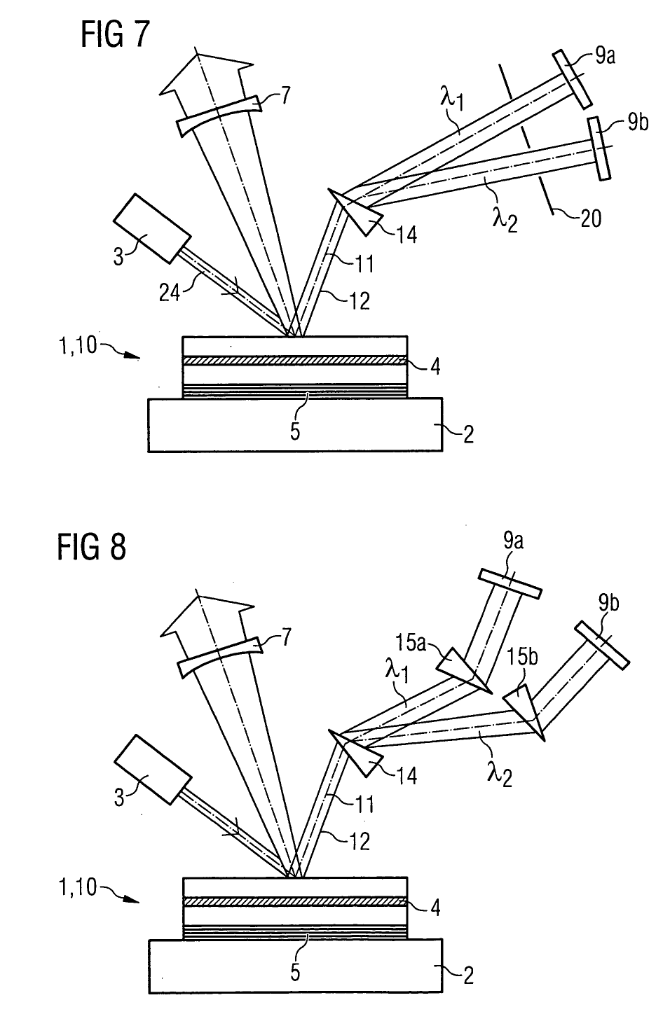

The sixth exemplary embodiment of the invention as illustrated in FIG. 7 represents a further development of the invention in which laser radiation having two different fundamental wavelengths can be generated simultaneously.

The semiconductor laser 1, including the pump radiation source, corresponds to the previous exemplary embodiments. The external resonator is divided into two resonator branches with a dedicated end mirror 9a, 9b by means of a dichroic or dispersive element, for example a prism 14. A blade or slit diaphragm 20 which can be displaced transversely with respect to the beam axes 11 may serve for setting the wavelength in the two resonator branches. The radiation having the wavelength λ₁ which is generated in one resonator branch and the radiation having the wavelength λ₂ which is generated in the other resonator branch are coupled out jointly through the coupling-out mirror 7. As in the exemplary embodiment shown in FIG. 5, the semiconductor body of the disc laser 1 serves as mode-locker 10 according to the principle of Kerr lens mode-locking. As an alternative, the end mirrors 9a, 9b may be embodied as an SESAM or an SESAM may be integrated into the disc laser.

It should be note that the laser device shown in FIG. 7 is also suited to generate continous wave radiation of two wavelenghts λ₁ and λ₂. This can by achieved by a slight detuning or misalignment of the mode-locker. Kerr lens mode-locker and a saturable absorber are very sensitive to the radiation intensity. Accordingly an increase of the beam waist due to a slight detuning or misalignment can reduce the radiation intensity at the location of the mode locker and switches off the mode-locking mechanism. For example a SESAM would then operate as if replaced by a conventional mirror.

FIG. 8 illustrates a seventh exemplary embodiment of the invention, which essentially corresponds to the exemplary embodiments shown in FIG. 5 and 7. In contrast thereto, as in the previous exemplary embodiment, the first prism 14 of the prism system is provided for splitting the resonator into two resonator branches. Arranged in the two resonator branches is a respective second prism 15a, 15b, which, together with the first prism 14 and the respective end mirror 9a, 9b, forms the respective device for phase compensation.

In addition, as in the previous exemplary embodiment, a slit diaphragm or blade may be provided for the purpose of wavelength selection. This is not absolutely necessary, however, since the prism system itself acts in wavelength-selective fashion in each case.

It should be noted that, instead of the prism or prisms, any other dispersive element, for example a grating, may also be used in the two-color lasers shown both in FIG. 7 and in FIG. 8.

For mode-locking, one of the end mirrors 9a, 9b or else both end mirrors 9a, 9b may be embodied as SESAM, as described previously. Equally, this device is suitable for Kerr lens mode-locking in the semiconductor laser 1.

In an advantageous development of this exemplary embodiment, the two pulses having different wavelengths λ₁ and λ₂ are coupled to one another. Cross-phase modulation may be used for this purpose for example given a suitable overlap of the pulses in the semiconductor body of the disc laser 1. This effects a phase-locked coupling of the pulses. This synchronization is distinguished by an advantageously small synchronization inaccuracy (jitter), which is typically less than 2 fs. Such a device may be utilized for simple external frequency conversion (e.g. SFG, DFG).

The abovementioned laser devices according to the invention are preferably embodied as a laser oscillator. However, it is also possible within the scope of the invention for the laser device to constitute a laser amplifier. In this case, laser pulses are coupled in externally, for instance through the coupling-out mirror and/or an optical switch, amplified and coupled out again. Thus, by way of example, a laser device according to the invention may be embodied as a CPA amplifier (chirped pulse amplification) with the disc laser as amplifier medium. In another variant of the invention, the laser device additionally comprises a laser amplifier which is arranged downstream of one of the above-described arrangements as a laser oscillator.

Furthermore, the invention may be utilized for efficient external or resonator-internal frequency conversion, for example in the context of so-called χ² processes such as frequency doubling, sum and difference frequency generation, so-called χ³ processes such as Raman processes, frequency tripling, or so-called higher-order χⁿ processes such as frequency quadrupling or generation of higher harmonics in nonlinear optical media.

LBO crystals, BBO crystals and GaAs and GaN surfaces are suitable, by way of example, as the nonlinear optical medium.

Given typical radiation powers of 0.01 W to 10 W, it is furthermore possible to realize a compact white light source by continuum generation, for instance by external focusing in water, glass, sapphire or BaF. Furthermore, it is possible to utilize further up and down converter substances such as luminescent substances or phosphors for generating other wavelengths.

The invention is not restricted by the description of the invention on the basis of the exemplary embodiments. Rather, the invention encompasses any new feature and also any combination of features, which comprises in particular any combination of features in the patent claims, even if this combination is not explicitly specified in the patent claims.

We claim:

1. A laser device for generating laser pulses with an optically pumped semiconductor laser (1), comprising:
an external resonator, and
at least one mode-locker (10).

2. The laser device as claimed in claim 1,
wherein
the semiconductor laser (1) is optically pumped by means of a pump radiation source (3) arranged externally.

3. The laser device as claimed in claim 1,
wherein
the semiconductor laser (1) is optically pumped by means of a pump radiation source (3a, 3b) which is monolithically integrated into the semiconductor laser (1).

4. The laser device as claimed in claim 1,
wherein
the mode-locker (10) is a passive mode-locker.

5. The laser device as claimed in claim 4,
wherein
the mode-locker (10) is a saturable absorber.

6. The laser device as claimed in claim 5,
wherein
the mode-locker is a saturable absorber made of a semiconductor material.

7. The laser device as claimed in claim 1,
wherein
the mode-locker (10) is monolithically integrated into the semiconductor laser (1).

8. The laser device as claimed in claim 1,
wherein
the mode-locker (10) is combined with a resonator mirror (9).

9. The laser device as claimed in claim 1,
wherein
the resonator has a device for phase compensation.

10. The laser device as claimed in claim 1,
wherein
a device for phase compensation is arranged downstream of the resonator.

11. The laser device as claimed in claim 9,
wherein
the device for phase compensation has at least one prism (14, 15, 16, 17), a grating, a linear or chirped mirror (19), a lens and/or an optical fiber.

12. The laser device as claimed in claim 11,
wherein
the resonator has a chirped folding mirror (19).

13. The laser device as claimed in claim 1,
wherein
the resonator has a first resonator branch for generating laser pulses having a fundamental wavelength λ₁ and a second resonator branch for generating laser pulses having a fundamental wavelength λ₂.

14. The laser device as claimed in claim 13,
wherein
the laser pulses having the fundamental wavelength λ₁ and the laser pulses having the fundamental wavelength λ₁ are coupled to one another in a phase-locked manner.

15. The laser device as claimed in claim 1,
wherein
the laser pulses have a pulse duration which is less than 100 ps, preferably less than 20 ps, particularly preferably less than 1 ps.

16. The laser device as claimed in claim 1,
wherein
the laser device is a laser oscillator.

17. The laser device as claimed in claim 1,
wherein
the laser device is a laser amplifier.

18. The laser device as claimed in claim 17,
wherein
the laser amplifier is a CPA amplifier.

19. The laser device as claimed in claim 1, wherein said mode-locker is arranged in said external resonator.

20. The laser device as claimed in claim 1, wherein a portion of the mode-locker is arranged internally and part is arranged externally of the semiconductor laser.
